(19) United States
(12) Patent Application Publication
(10) Pub. No.: US 2006/0289289 A1
(43) Pub. Date: Dec. 28, 2006

(54) Purification of organic compositions by sublimation

(76) Inventor: Christian Kloc, New Providence, NJ (US)

Correspondence Address: Lucent Technologies Inc.;Docket Administrator, Room 3J-219, 101 Crawfords Corner Road, Holmdel, NJ, 07733-3030, US

(21) Appl. No.: 11/159,781

(22) Filed: Jun. 23, 2005

(51) Int. Cl. B01D 3/00

(52) U.S. Cl. 203/71

(57) ABSTRACT

A method purifies a starting solid or semi-solid organic composition located in a chamber. The method includes heating the starting organic composition such that molecules of one organic molecular species sublime out of the composition and molecules of a desired organic molecular species remain in the composition. The method includes pumping the chamber during the heating step to remove sublimed organic molecules. The method includes then, heating a remaining portion of the composition at one or more higher temperatures such that molecules of the desired organic molecular species sublime from the remaining portion of the composition. A separate region of the chamber is maintained under conditions that cause deposition of sublimed molecules of the desired species during the heating a remaining portion.

### BACKGROUND

1. Field of the Invention

The invention relates to methods and devices for purifying organic compositions.

2. Discussion of the Related Art

Often, it is advantageous to have samples of organic molecules of high purity. Unfortunately, many of the processes for synthesizing organic molecules produce impure compositions. For that reason, it is often necessary to purify an organic composition to obtain a sample with a desired level of purity. Pure samples of organic molecules have uses in microelectronics, chemistry, biology, and the pharmaceuticals industry.

### BRIEF SUMMARY

Various embodiments provide methods for extracting purified samples of organic molecules from impure starting organic compositions. The starting organic compositions may be in solid or semi-solid form, e.g., a solid object, a powder, or a paste.

One embodiment features a method for purifying a starting solid or semi-solid organic composition located in a chamber. The method includes heating the starting solid or semi-solid organic composition such that molecules of one organic molecular species sublime out of the composition and molecules of a desired organic molecular species remain in the composition. The method includes pumping the chamber during the heating step to remove sublimed organic molecules. The method includes then, heating a remaining portion of the composition at one or more higher temperatures such that molecules of the desired organic molecular species sublime from the remaining portion of the composition. A separate region of the chamber is maintained under conditions that cause deposition of sublimed molecules of the desired organic molecular species therein during the heating a remaining portion.

Another embodiment features an apparatus that includes a hermetically sealed, elongated, silicate glass ampoule and a pure sample of a single organic molecular species located in the ampoule. The ampoule has glass bumps at opposite ends of a hollow cavity therein.

Another embodiment features a method for purifying a starting organic composition located in a chamber. The method includes heating the starting organic composition at one or more first temperatures to sublime molecules from the composition. The one or more first temperatures are below a sublimation temperature of a desired organic molecular species. The method includes pumping the chamber during the first heating step to remove subliming molecules. The method includes then, heating a remaining portion of the organic composition at one or more second temperatures to sublime the desired organic molecular species from the remaining portion of the organic composition. The one or more second temperatures are equal to or greater than the sublimation temperature for the desired molecular species. A region of the chamber is maintained under conditions that enable crystallization of sublimed molecules of the desired organic molecular species during the second heating step.

### BRIEF DESCRIPTION OF THE DRAWINGS

Various embodiments are described in the Figures and Detailed Description of Illustrative Embodiments. Nevertheless, the inventions may be embodied in various forms and are not limited to the embodiments of the Figures and Detailed Description of Illustrative Embodiments.

FIG. 1A shows one exemplary apparatus for purifying organic compositions by sublimation;

FIG. 1B shows another exemplary apparatus for purifying organic compositions by sublimation;

FIG. 2 illustrates an exemplary vacuum system for use with the apparatus of FIGS. 1A and 1B;

FIG. 3 illustrates how the purification chamber of FIGS. 1A or 1B may be sealed under an inert gas atmosphere to form an ampoule that holds a pure sample of a desired organic molecular species;

FIG. 4 is a flow chart illustrating an embodiment of a method for purifying organic compositions, e.g., using the exemplary apparatus of FIGS. 1A or 1B;

FIG. 5A illustrates the temperature along the purification chambers of FIGS. 1A and 1B during a first sublimation step of the method of FIG. 4;

FIG. 5B illustrates the temperature along the purification chambers of FIGS. 1A and 1B during a second sublimation step of the method of FIG. 4; and

FIG. 6 illustrates an alternate exemplary device for purifying compositions of organic molecules, e.g., according to the method of FIG. 4.

In the Figures and text, like reference numerals indicate elements with similar functions.

### DETAILED DESCRIPTION OF ILLUSTRATIVE EMBODIMENTS

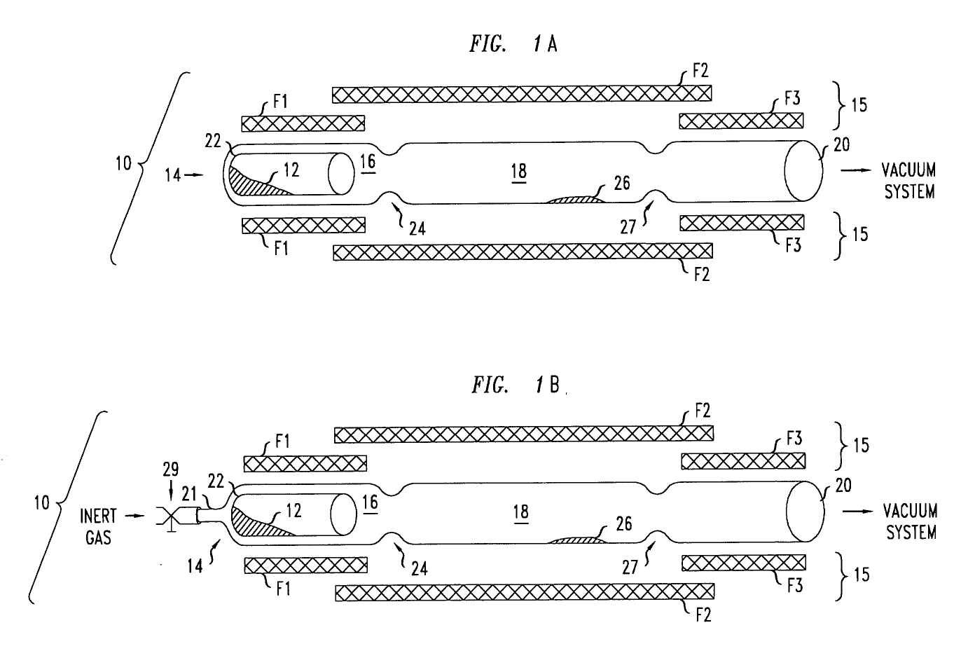

FIGS. 1A and 1B show alternate embodiments of apparatus 10 for extracting a desired organic molecular species from an impure starting organic composition 12. The starting organic composition 12 includes a mixture of different species of organic molecules, e.g., having different sublimation temperatures. Often, the starting organic composition 12 will be a mixture of molecules of different molecular weights. The starting composition 12 may be a solid or semi-solid, e.g., a solid object, a powder, or a paste. Such starting compositions 12 of organic molecular species are produced by many conventional chemical syntheses.

While a pure solid sample of a molecular species often has a nonzero vapor pressure over a large temperature range, the vapor pressure of such a sample often changes rapidly over a much narrower temperature range, i.e., here referred to as the change range. Above the change range, the sample sublimes at an observable rate, and below the change range, the sample sublimes at a rate that is substantially insignificant compared to the rate above the change range. The sublimation temperature of a molecular species is the lower limit of the above-describe change range for a pure sample of the molecular species. Those of skill in the art will recognize that many molecular species have well-defined sublimation temperatures and sublimation properties that seem to change abruptly near said sublimation temperatures due to the narrowness of the associated change ranges.

The apparatus 10 includes a purification chamber 14 and a furnace 15.

The purification chamber 14 includes a holding region 16, a crystallization region 18, and an exit and/or entrance port 20 for gases. The holding region 16 holds the impure starting composition 12 to be processed. The starting composition 12 may be located in a separate sample holder 22 that is itself located in the holding region 16. Such a sample holder 22 may be used to load the composition 12 in a manner that avoids contamination of the purification chamber 14. The holding region 16 connects to the crystallization region 18 via a narrow neck region 24 that enables gas transport between the two regions 16, 18. The crystallization region 18 provides an area where some sublimed organic molecules can be deposited to form purified crystals or crystallites 26 of the desired molecular species. The crystallization region 18 also connects via a narrow neck 27 to the port 20. The port 20 allows gases to be pumped out of or into the purification chamber 14.

The furnace 15 has multiple heating segments F1, F2, F3. The heating segments F1-F3 enable separate control of temperatures in the regions 16, 18, 20 of the purification chamber 14. In particular, the heating segments F1-F3 enable the maintenance of temperature differences between these regions 16, 18, 20 during the purification process. The ends of heating segments F1 and F2 are positioned to overlap around neck region 24, and the ends of heating segments F2 and F3 are positioned to overlap around neck region 27.

In FIG. 1B, the purification chamber 14 includes an additional port 21 that is located at one end of the holding region 16. The second port 21 connects via adjustable needle valve 29 to an inert gas source, e.g., a source of a Nobel gas such an argon, helium, neon, or krypton. The valve 29 enables regulation of the inert gas flow into the holding region 16. The inert gas flow can help to move sublimed material from the holding region 16 to the crystallization region 18 or to port 20 during the purification process.

Referring to FIG. 1A, an exemplary purification chamber 14 may be fabricated from a starting test tube of borosilicate glass, e.g., a PYREX glass test tube. The starting test tube has a length of about 31 centimeters (cm), an outer diameter of about 1.3 cm, and an inner diameter of about 1 cm. With such a starting test tube, the fabrication of the exemplary purification chamber 14 is a three-step process.

The first step involves loading the starting test tube with the impure organic starting composition 12. For a powdered organic starting composition 12, the loading may include loading the impure organic starting composition 12 into sample holder 22 and then, sliding the loaded sample holder 22 into the larger starting test tube. The sample holder 22 may, e.g., be a borosilicate glass test tube having a length of about 4.4 cm and an outer diameter of about 0.9 cm. Using the sample holder 22 reduces the risk of contaminating other parts of the other starting test tube with the impure organic starting composition 12 during loading. For example, contamination risks are lower than when a powdered organic starting composition 12 is poured directly into the starting test tube.

The second step involves glass working the starting test tube to produce the narrow neck region 24 that separates the holding and crystallization regions 16, 18. The neck region 24 has, e.g., an inner diameter of about 0.5 cm and is positioned so that the holding and crystallization regions 16, 18 have respective lengths of about 8 cm and about 12 cm. The glass working involves heating a longitudinal portion of the starting test tube to soften the glass therein, then pulling the starting test tube to produce the neck region 24 from the softened longitudinal portion, and then allowing the softened glass to cool.

The third step involves again glass working the starting test tube to produce narrow neck region 27 that separates the crystallization region 18 and the port 20. The neck region 27 has an inner diameter of about 0.5 cm and is positioned so that the crystallization region 18 and the port 20 have respective lengths of about 12 cm and about 11 cm. The glass working involves heating a longitudinal portion of the test tube to soften the glass therein, then pulling the test tube to produce the neck region 27, and then allowing the softened glass to cool.

Forming the purification chamber 14 of FIG. 1B involves an extra step to produce the added port 21. The extra step can be performed prior to loading the impure organic sample into the starting 31 cm long borosilicate glass test tube. The extra step may include heating a longitudinal region of the starting test tube near its closed end, pulling that end of the starting test tube glass to form a tube from the softened glass, cooling the deformed starting test tube, and breaking off a distal portion of the formed tube to make an external entrance for the port 21.

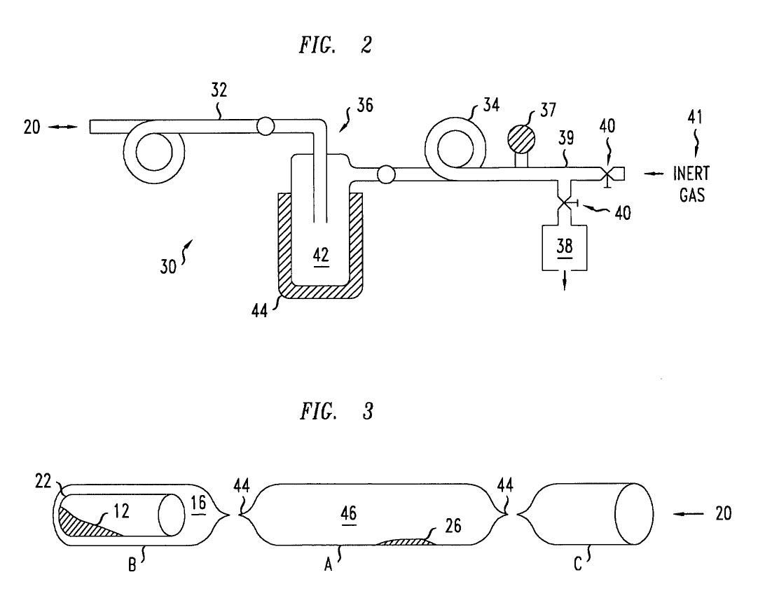

FIG. 2 shows an exemplary vacuum system 30 suitable for use with the apparatus 10 of FIGS. 1A and 1B. The system 30 includes flexible vacuum tubes 32, 34, a material trap 36, a vacuum gauge 37, a vacuum pump 38, a coupler 39 with adjustable needle valves 40, and an inert gas source 41. One flexible vacuum tube 32 fits over the port 20 and forms the vacuum connection between the purification chamber 14 to an input adapter on the material trap 36. The other flexible vacuum tube 34 connects an output adapter of the material trap 36 to the coupler 39 that connects to the vacuum pump 38. The material trap 36 includes a trap chamber 42 that is cooled by a dry ice—filled jacket 44. The material trap 36 traps gaseous organic molecules of moderate weight thereby protecting the vacuum pump 38 from being contaminated by sublimed molecules from the purification chamber 14. The vacuum pump 38 is able to provide moderate vacuums, e.g., around 0.1 Torr or lower, in the purification chamber 14. The inert gas source 41 is, e.g., a source of a Nobel gas such as argon, helium, neon, or krypton. The inert gas source 41 is connected to the pump 38 via the coupler 39 and adjustable needle valves 40. The inert gas source 40 provides an inert gas for the vacuum system 30 so that internal pressures in the purification chamber 14 can be kept between about 0.1 Torr and 10 Torr or lower.

Referring to FIGS. 1A, 1B, and 2, the apparatus 10 and system 30 can extract pure samples of organic molecular species from impure compositions 12 that are mixtures in which different organic molecular species having different vapor pressures or sublimation temperatures. Organic synthesis often produces a mixture of molecules having similar functional groups and a range of molecular weights. The differences in molecular weights can, e.g., cause the molecules of such mixtures to have different sublimation temperatures. Such mixtures may include some molecules that are too heavy to be significantly sublimed, because the molecules chemically change at temperatures below those needed to sublime the molecules.

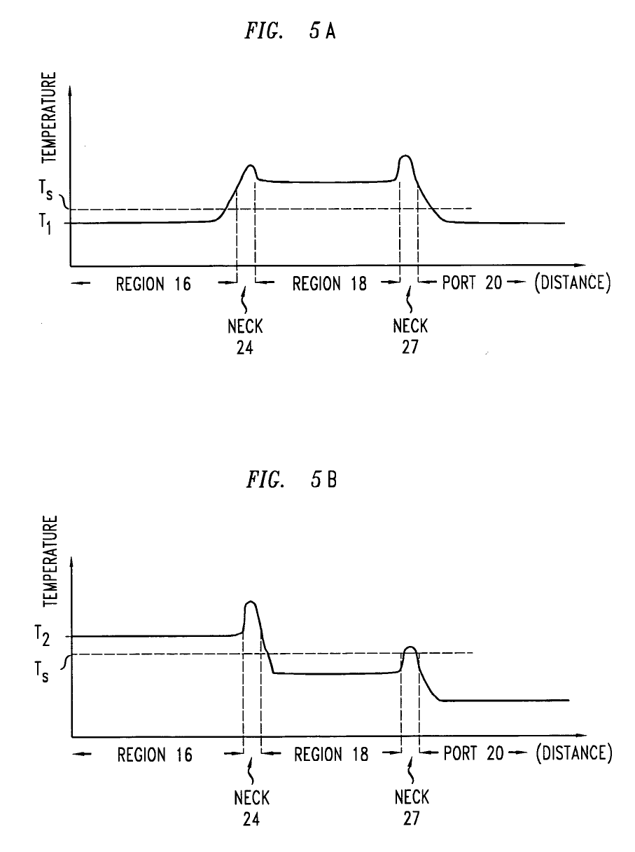

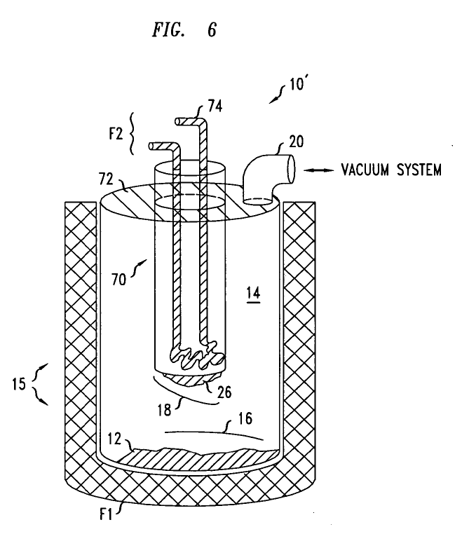

FIG. 4 illustrates a method 50 for extracting a pure sample of a desired organic molecular species from a starting organic composition that includes multiple organic molecular species with different sublimation temperatures. In some embodiments, the method 50 is performed with the apparatus 10 and vacuum system 30 of FIGS. 1A and 2 or the apparatus 10 and vacuum system 30 FIGS. 1B and 2. For such embodiments, FIG. 5A and FIG. 5B illustrate exemplary spatial temperature distributions along the axis of the purification chamber 14 during the step 52 and the step 54, respectively.

The method 50 includes heating and maintaining the starting organic composition at one or more first temperatures, T₁, such that one or more species of organic molecules sublime(s) out of the starting organic composition while a desired species of organic molecules remains in the starting organic composition (step 52). For example, the starting organic composition may be the solid or semi-solid starting organic composition 12 of FIGS. 1A-1B. During the heating, the interior surface of the purification chamber, e.g., the purification chamber 14 of FIGS. 1A-1B, is maintained at or above the one or more first temperatures, T₁. During the heating, the temperature of the crystallization region of the purification chamber, e.g., the crystallization region 18 of FIGS. 1A-1B, is maintained at or above the one or more first temperatures, T₁, to stop deposition of sublimed molecules therein. Otherwise, such sublimed molecules could form deposits that contaminate the crystallization region. During the heating step, some sublimed molecules may be deposited at the exit port of the purification chamber, e.g., the port 20 of FIGS. 1A-1B, but the exit port is preferably maintained under conditions that stop it from being blocked by such depositions. For example, the narrow neck regions 24, 27 of the purification chamber 14 are kept at a temperature above the one or more temperatures, T₁, to avoid blockages due to depositions therein. During the heating step, the starting composition is, e.g., kept below a sublimation temperature, T_{S}, of the desired species of organic molecules to stop significant losses of the desired molecular species through sublimation. During the heating step, the purification chamber is pumped to maintain vacuum conditions therein, e.g., due to a negative pressure applied to exit port 20 of FIGS. 1A-1B with the vacuum system 30. Due to the pumping, some sublimed molecules are removed from the purification chamber rather than forming deposits therein.

Typically, the heating step 52 causes undesired light organic molecules to sublime and be removed from the starting organic composition. For the transparent purification chamber 14, the progress of the removal of such undesired organic molecular species may be tracked visually by monitored the remaining size or mass of the starting organic composition 12 in the holding region 16 and/or monitored by the deposition of material in entrance port 20. As more molecules sublime, the size and/or mass of the starting composition 12 decreases. The heating step 52 is terminated when changes to the size and/or mass of the remaining portion of the starting organic composition 12 stop, e.g., due to a substantial absence therein of organic molecules that sublime at the temperature, T₁.

Next, method 50 includes heating and maintaining a remaining unsublimated portion of the starting organic composition at one or more higher temperatures, T₂, such that the desired species of organic molecules sublime from the remaining portion of the starting organic composition (step 54). The one or more temperatures, T₂, are, e.g., at or above the sublimation temperature, T_{S}, of the desired organic molecular species so that the molecules of that species sublime out of the remaining mass of the starting organic composition, e.g., out of the remaining portion of the starting organic composition 12 of FIGS. 1A-1B. During the step 54, the desired molecular species has a sublimation rate that is at least two times higher and is typically much higher than the sublimation rate during the first heating step 52. During this second heating step 54, special conditions are used to cause sublimed molecules to be preferentially deposited in a separate crystallization region of the purification chamber, e.g., the crystallization region 18 of FIGS. 1A-1B. The special conditions include, e.g., maintaining the crystallization region at a temperature that is lower than the sublimation temperature, T_{S}, for the desired molecular species. That is, the crystallization region is maintained at a temperature low enough for crystallization of the desired molecular species. The special conditions may also include maintaining a background partial pressure of an inert gas such as argon in the purification chamber, e.g., a partial pressure between about 0.1 and 10 Torr. This background partial pressure of the inert gas reduces the mean free path of the sublimed desired organic molecules, e.g., to be less than the inner linear dimensions of the purification chamber. For the purification chamber 14 of FIGS. 1A-1B, the resulting mean free path is, e.g., less that the length of the crystallization region 18. In the purification chamber 14, such a short mean free path substantially increases the probability that sublimed desired organic molecules will crystallize in the crystallization region 18 rather escaping via port 20. During the second heating step 54, any neck regions of the purification chamber, e.g., neck regions 24, 27, may also be maintained at a temperature above such a sublimation temperature, T_{S}, of the desired molecular species so that crystallization of such sublimed molecules does not cause blockages therein.

This second heating step 54 causes purified crystals of the desired molecular species to grow in the crystallization region, e.g., chemically pure crystals 26 in the crystallization region 18 of FIGS. 1A-1B. The second heating step 54 also leaves impurity organic molecular species at the location of the original mass of the starting composition, e.g., in the holding region 16 of FIGS. 1A-1B. The impurity organic molecular species may, e.g., include heavier organic molecules with yet higher sublimation temperatures and/or organic molecular species that cannot be sublimed.

In exemplary glass purification chamber 14, the progress of the sublimation of the desired organic molecular species may be tracked visually by monitoring a size or volume. That is, the remaining mass of the starting composition may be visually monitored, e.g., the portion of the starting organic composition 12 in the holding region 16 of FIGS. 1A-1B, or the deposited mass of the desired molecular species in the crystallization region may be visually monitored, e.g., the mass 26 in the crystallization region 18 of FIGS. 1A-1B. As more molecules sublime, the visible mass of the remaining composition in the holding region decreases, and the visible solid mass in the crystallization region increases. The second heating step 54 is stopped, e.g., by cooling the whole purification chamber 14 when changes to either the mass 12 or the mass 26 of FIGS. 1A-1B stops or slows substantially.

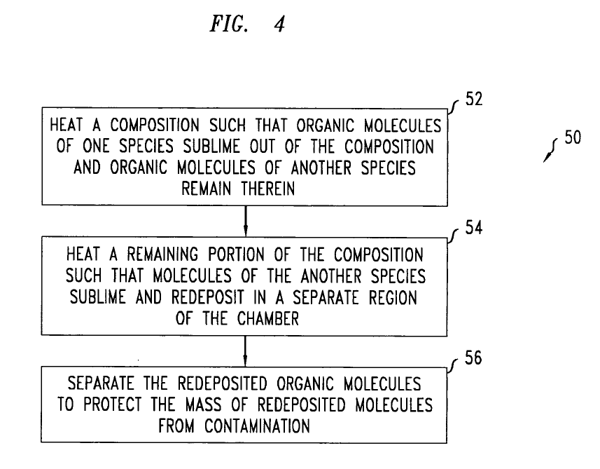

Next, the method 50 includes separating the deposited and purified mass of the desired molecules to protect this purified sample from subsequent contamination, e.g., the mass 26 of FIGS. 1A-1B (step 56). For the purification chamber 14 of FIGS. 1A-1B, the separating step involves heat softening the glass near the neck regions 24, 27. Then, the crystallization region 18 may be gently twisted to hermetically seal off the neck regions 24, 27 thereby forming a sealed glass ampoule A as shown in FIG. 3. The separating step typically produces a separated glass structure B from the holding region 16, and a separated glass structure C from the original glass tube at the port 20. The separating step also typically forms solid glass bumps or protrusions 44 at both ends of the hollow cavity 46 of the ampoule A

After the softened glass cools, the ampoule A is a hermetic container that efficiently protects the purified mass 26 of the desired molecular species, e.g., crystals, from external contamination. The ampoule A may sealed while under a substantial partial pressure of an inert gas such as argon, i.e., so that the final ampoule contains an inert gas atmosphere. Such a partial pressure of inert gas is introduced during the separation step 56. In particular, it may be advantageous to form the ampoule A so that it the inert gas therein will produce an internal pressure of 1±0.1 atmospheres after cooling to room temperature. Such an internal pressure of inert gas can impede ambient gas from entering the ampoule A when one end is later opened to remove part of the purified sample 26 of organic molecules therein. During such a subsequent opening, an entry of ambient gas into the ampoule A could otherwise contaminate the remaining purified sample 26 in the ampoule A.

The method 50 may be used to purify or extract a variety of desired organic molecular species from complex starting organic compositions. Examples may include organic molecular species useful in the microelectronics industry, e.g., pentacene, rubrene, and tetracene; organic molecular species useful in chemistry; organic molecular species having biological applications, e.g., thymine; or organic molecular species useful in pharmaceuticals.

FIG. 6 shows an alternate apparatus 10′ for purifying compositions of organic molecules, e.g., according to the method 50 of FIG. 4. The apparatus 10′ includes a closed purification chamber 14 and a furnace 15 with heating element F1. The purification chamber 14 has a holding region 16 for the impure starting organic composition 12 and a crystallization region 18 for depositing the sublimed organic molecules of the desired species. The crystallization region 18 is located on a physical insert 70 that passes through a sealing cap 72 for the purification chamber 14. The insert 70 includes wires 74 for carrying an electrical current. The wires 74 form another heating element F2 that enables heating the crystallization region 18 to a higher temperature than the holding region 16 during step 52 of the method 50. The sealing cap 72 also includes a port 20 that couples the closed purification chamber 14 to an external vacuum system, e.g., the vacuum system 30. The vacuum system, e.g., enables removal of sublimed gaseous organic molecules during step 52 of the method 50 and the introduction of an inert gas during the step 54 of the method 50.

In the apparatus 10′, the purification chamber 14, sealing cap 72, and physical insert 70 may be made of a variety of materials, e.g., silicate glasses, metals, and/or ceramics.

### EXAMPLE

Thymine was extracted/purified from a commercial organic composition via the method 50 of FIG. 4. The extraction/purification used a slightly different apparatus than the apparatus 10 of FIG. 1A. For example, the used apparatus had a purification chamber 14 whose exit port was a narrow tube rather than the wide port 20 shown in FIG. 1A. The narrow tube had a tip diameter of about 0.3 cm. The extraction/purification also used a somewhat different furnace. The furnace included an outer heating element about as long as the purification chamber and inner heating elements around the holding region 16 and the narrow tube for the exit port. The starting organic composition was purchased from the Sigma-Aldrich Company, www.sigmaaldrich.com, and was advertised as having, at least, 99% thymine by weight.

The exemplary extraction/purification according to the method 50 proceeded under the following conditions. In the first step 52, the furnace heated the exemplary borosilicate glass purification chamber to about 180° C. under vacuum conditions. This first heating step caused a sublimation of lighter organic molecules thereby producing a visible deposition of a white material in the purification chamber's exit port. In the second step 54, the furnace F1-F3 was readjusted so as to heat both the remaining portion of the starting organic composition 12 in the holder region 16 and the exit port to about 250° C. while maintaining the crystallization region 18 at about 180° C. During the second heating step, the vacuum system 30 maintained a background partial pressure of argon at about 3 Torr in the purification chamber. The second heating step 54 was continued until the observed size/volume of the mass of starting composition 12 visibly appeared to stop decreasing. During the second heating step, white crystals 26 of thymine formed on the walls of the crystallization region 18. The third step involves heating ends of the crystallization chamber 18 to soften the glass therein and then, deforming the softened glass to form a hermetically sealed borosilicate glass ampoule, e.g., ampoule A of FIG. 3, containing a purified thymine powder and a partial pressure of the inert argon gas.

From the disclosure, drawings, and claims, other embodiments of the invention will be apparent to those skilled in the art.

What we claim is:

1. A method for purifying a starting solid or semi-solid organic composition located in a chamber, comprising:
heating the starting solid or semi-solid organic composition such that molecules of one organic molecular species sublime out of the composition and molecules of a desired organic molecular species remain in the composition;
pumping the chamber during the heating to remove sublimed organic molecules; and
then, heating a remaining portion of the composition at one or more higher temperatures such that molecules of the desired organic molecular species sublime from the remaining portion of the composition, a separate region of the chamber being maintained under conditions that cause deposition of sublimed molecules of the desired organic molecular species therein during the heating a remaining portion.

2. The method of claim 1, wherein the first heating step maintains the composition below a sublimation temperature of the desired organic molecular species and the second heating step causes the portion of the composition to have one or more temperatures greater than said sublimation temperature.

3. The method of claim 1, further comprising maintaining a pressure of a background gas in the chamber during the second heating step.

4. The method of claim 3, wherein the background gas is an inert gas.

5. The method of claim 2, wherein the region is held below the sublimation temperature during the heating of a remaining portion.

6. The method of claim 1, further comprising stopping the heating of a remaining portion of the composition prior to subliming the entire remaining portion.

7. The method of claim 1, wherein the desired molecular species has a sublimation rate, the sublimation rate during the second heating step being at least two times higher than the sublimation rate during the first heating step.

8. An apparatus, comprising:
a hermetically sealed, elongated, silicate glass ampoule; and
a pure sample of a single organic molecular species located in a hollow cavity in the ampoule; and
wherein the ampoule has glass bumps at opposite ends of the hollow cavity.

9. The apparatus of claim 8, wherein the silicate glass is a borosilicate glass.

10. The apparatus of claim 8, wherein the sample is a crystalline sample.

11. The apparatus of claim 8, wherein the ampoule includes a partial pressure of a noble gas.

12. The apparatus of claim 8, wherein the partial pressure between about 0.9 atmospheres and about 1.1 atmospheres.

13. The apparatus of claim 11, wherein the gas is argon.

14. The apparatus of claim 11, wherein the sample has a sublimation temperature.

15. The apparatus of claim 11, wherein a sublimation rate of the sample below the sublimation temperature is at least 2 times smaller than the sublimation rate of the sample at a temperature above the sublimation temperature.

16. A method for purifying a starting organic composition located in a chamber, comprising:
heating the starting organic composition at one or more first temperatures to sublime molecules from the composition, the one or more first temperatures being below a sublimation temperature of a desired organic molecular species;
pumping the chamber during the heating to remove subliming molecules; and
then, heating a remaining portion of the organic composition at one or more second temperatures to sublime the desired organic molecular species from the remaining portion of the organic composition, the one ore more second temperatures being equal to or greater than the sublimation temperature for the desired molecular species, a region of the chamber being maintained under conditions that enable crystallization of sublimed molecules of the desired organic molecular species during the second heating step.

17. The method of claim 16, further comprising maintaining a pressure of an inert background gas in the chamber during the second heating step.

18. The method of claim 16, wherein the region is held at a temperature lower than the sublimation temperature during the second heating step.

19. The method of claim 16, further comprising stopping the heating of a remaining portion of the composition prior to the remaining portion disappearing.
